(19) United States
(12) Patent Application Publication
(10) Pub. No.: US 2003/0158995 A1
(43) Pub. Date: Aug. 21, 2003

(54) Method for DRAM control with adjustable page size

(76) Inventors: Ming-Hsien Lee, Hsinchu (TW); Yi-Kang Wu, Taichung (TW); Chien-Ming Chen, Changhua Hsien (TW)

Correspondence Address: BIRCH STEWART KOLASCH & BIRCH, PO BOX 747, FALLS CHURCH, VA, 22040-0747, US

(21) Appl. No.: 10/075,454

(22) Filed: Feb. 15, 2002

(51) Int. Cl. G06F 12/00

(52) U.S. Cl. 711/105; 711/170

(57) ABSTRACT

A method for dynamic random access memory (DRAM) control with adjustable page size, including the following steps. During power-up initialization, a DRAM type is identified and a page mask for the DRAM type is set. Upon receipt of a DRAM access, an adjustable page portion of an internal address for the prior DRAM access and an adjustable page portion of an internal address for a next DRAM access are respectively determined in accordance with the page mask. A first portion of the internal address for the prior DRAM access is compared to a first portion of the internal address for the next DRAM access, and the adjustable page portion of the internal address for the prior DRAM access is compared to the adjustable page portion of the internal address for the next DRAM access, to determine whether the next DRAM access is a page hit or miss.

### FIELD OF THE INVENTION

The present invention relates generally to a memory control method and, in particular, to a method for dynamic random access memory (DRAM) control with adjustable page size.

### BACKGROUND OF THE INVENTION

A conventional computer system, as shown in FIG. 1, has a host bus 160, a peripheral bus or PCI bus 170 and a graphics bus or AGP bus 180. The host bus 160 connects a central processing unit (CPU) 110 and a cache 130 to a bus interface unit or north bridge 120. The cache 130 can be embodied within or external to CPU 110. The north bridge 120 interfaces the slower PCI bus 170 and the faster host bus 160. The north bridge 120 may have a memory controller which allows communication to and from a system memory 140. The north bridge 120 may also include a graphics port to allow connection to a graphics accelerator 150. A graphics port, such as AGP, provides a high performance, component level interconnect targeted at three dimensional graphic display applications.

The memory controller receives memory access request from, e.g., the PCI bus 170, the AGP bus 180, and/or the CPU 110. A memory access request includes address and read/write information. The memory controller satisfies memory access requests by asserting the appropriate control signals to the system memory 140. For DRAM-type memory, these control signals may include address signals, row address strobe (RAS), column address strobe (CAS), and memory write enable (WE). The system memory 140 typically supports multiple DRAM modules. Various module structures may be employed such as single in-line memory modules (SIMMs), or dual in-line memory modules (DIMMs).

Throughput to the system memory 140 is one of the most important factors for determining system performance. One technique used to improve memory throughput is called paging. A page may be defined as an area in a memory bank accessed by a given row address. A page is “opened” when a given row address is strobed in. If a series of access are all to the same page, then once the page is open, only column addresses need be strobed in to the memory bank. Thus, the RAS precharge time is saved for each subsequent access to the open page. Therefore, paging involves leaving a memory page open as long as accesses continue to “hit” within that page. Once an access “misses” the page, the old page is closed and a new page is opened. Opening a new page may incur a precharge time, since only one page may typically be open within a memory bank.

DRAM type is generally denoted as BA×RA×CA, in which RA is the number of row address bits, CA is the number of column address bits, and BA is the number of bank address bits. Presently, many DRAM types are available, such as 1×11×8, 2×12×10, and 2×13×12, etc. The number of column address bits determines DRAM page size, i.e., page size is 2^{CA}×2³ bytes. For instance, the page size of a DRAM with CA=8 is 2⁸×2³, e.g., 2K bytes.

Various types of DRAM may be installed in a computer system at the same time, for example, a DRAM module with 2 K-byte (2 KB) page size and two DRAM modules with 8 KB page size may be installed in a computer system simultaneously. A prior art memory controller dealing with the above-described condition uses a constant page size with 2 KB no matter what types of DRAM modules are installed. However, this method lowers the page hit rate when the page size is larger than 2 KB. Typically, a larger page size within a memory results in higher hit rate. A prior art memory controller maps an interleaving physical address into a column address of DRAM, so that the memory page was divided into several segments. For example, the memory space of an 8 KB page DRAM is shown in FIG. 2. The page 0 of the 8 KB page DRAM is divided into four 2 KB segments 200a˜d, in terms of hexadecimal address, 0˜7FFh, 2000000h˜20007FFh, 4000000h˜40007FFh, and 6000000h˜60007FFh respectively. Compared with a consecutive address mapping shown in FIG. 3, the same page 0 has a whole 8 KB segment 300 within the address space. Thus, for the DRAMs with same page size, the consecutive address mapping design can get a higher page hit rate than the interleaving address mapping design.

Accordingly, what is needed is a memory controller that improves system memory throughput, unencumbered by the limitations associated with the prior art.

### SUMMARY OF THE INVENTION

It is an object of the present invention to provide a method for DRAM control with adjustable page size to raise the page hit rate.

It is another object of the present invention to provide a memory control method using the adjustable page size and the consecutive address mapping design to improve computer system performance.

The present invention is directed to a method for DRAM control with adjustable page size. In one aspect of the invention, the method includes the following steps. A DRAM type is identified first. According to the DRAM type, a maximum page size of the DRAM is determined and a page mask for the DRAM is set. A transaction is performed in response to a prior DRAM access. Following the prior DRAM access, a next DRAM access is received. An adjustable page portion of an internal address for the prior DRAM access and an adjustable page portion of an internal address for the next DRAM access, in accordance with the page mask, are determined respectively. The next DRAM access is determined if it is a page hit or miss. When a first portion of the internal address for the prior DRAM access matches a first portion of the internal address for the next DRAM access and the adjustable page portion of the internal address for the prior DRAM access matches the corresponding adjustable page portion of the internal address for the next DRAM access, a page hit access occurs. Subsequently, a second portion of the internal address for the next DRAM access is mapped, according to the maximum page size, into a column address of the DRAM, in which address bits of the second portion are consecutive.

In another aspect of the invention, a memory control method for a computer system is disclosed. The computer system includes one or more DRAM modules installed therein. The DRAM types of the installed DRAM modules are identified first. According to the respective DRAM types, a maximum page size of each DRAM module is determined and a page mask for each DRAM module is set. An internal address for a prior DRAM access is stored, in which the internal address includes a first portion, a second portion and a third portion. Following the prior DRAM access, a next DRAM access is received. One of the DRAM modules is selected as a next selected module in accordance with an internal address for the next DRAM access. A third portion of the internal address for the prior DRAM access is masked with the page mask corresponding to a prior selected module to produce an adjustable page portion of the internal address for the prior DRAM access. As well, a third portion of an internal address for the next DRAM access is masked with the page mask corresponding to the next selected module to produce an adjustable page portion of the internal address for the next DRAM access. The next DRAM access is determined whether it is a page hit access or not. When a first portion of the internal address for the prior DRAM access matches a first portion of the internal address for the next DRAM access and the adjustable page portion of the internal address for the prior DRAM access matches the corresponding adjustable page portion of the internal address for the next DRAM access, a page hit access occurs. Thereafter, a second portion of the internal address for the next DRAM access is mapped, according to the maximum page size corresponding to the next selected module, into a column address of the DRAM, wherein address bits of the second portion are consecutive.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram of an exemplary computer system;

FIG. 2 illustrates a memory mapping of a prior art memory controller;

FIG. 3 illustrates a memory mapping of the invention;

FIG. 4 illustrates a block diagram useful in understanding the operation of a memory controller according to the invention; and

FIG. 5 illustrates a flowchart of a method for DRAM control with adjustable page size.

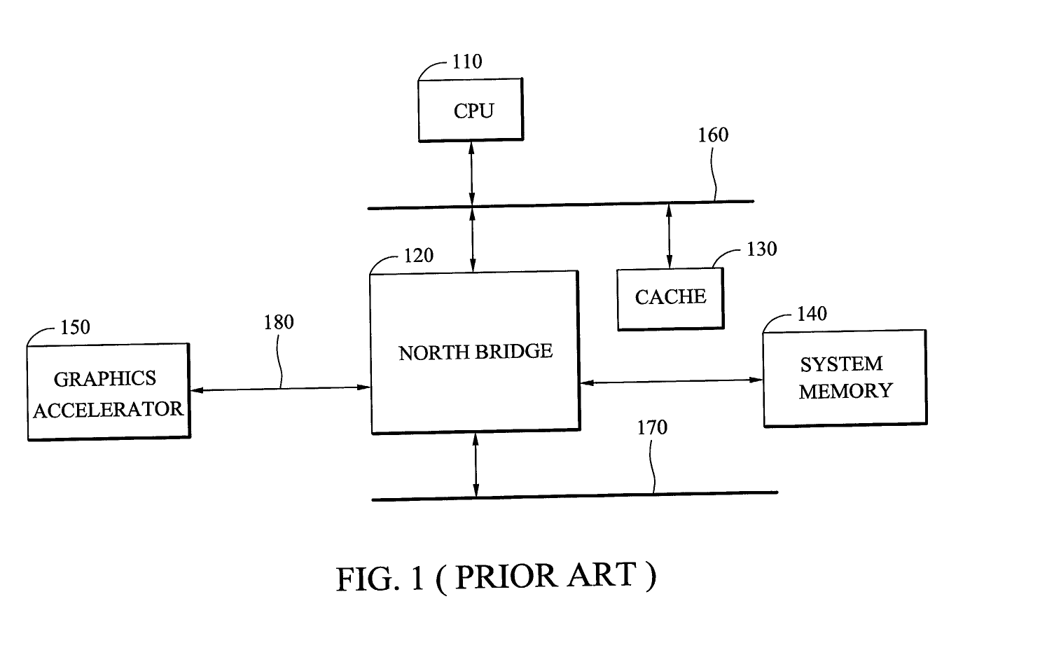

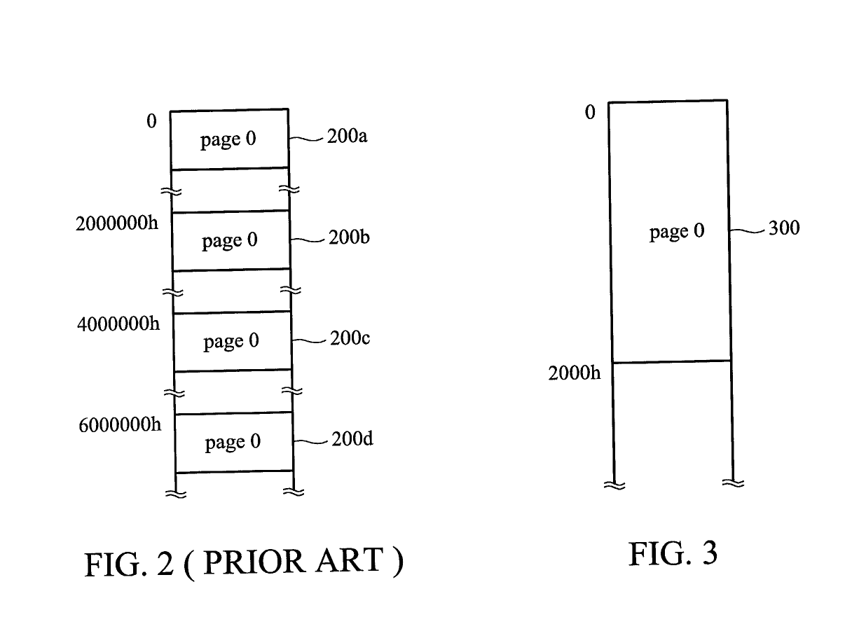

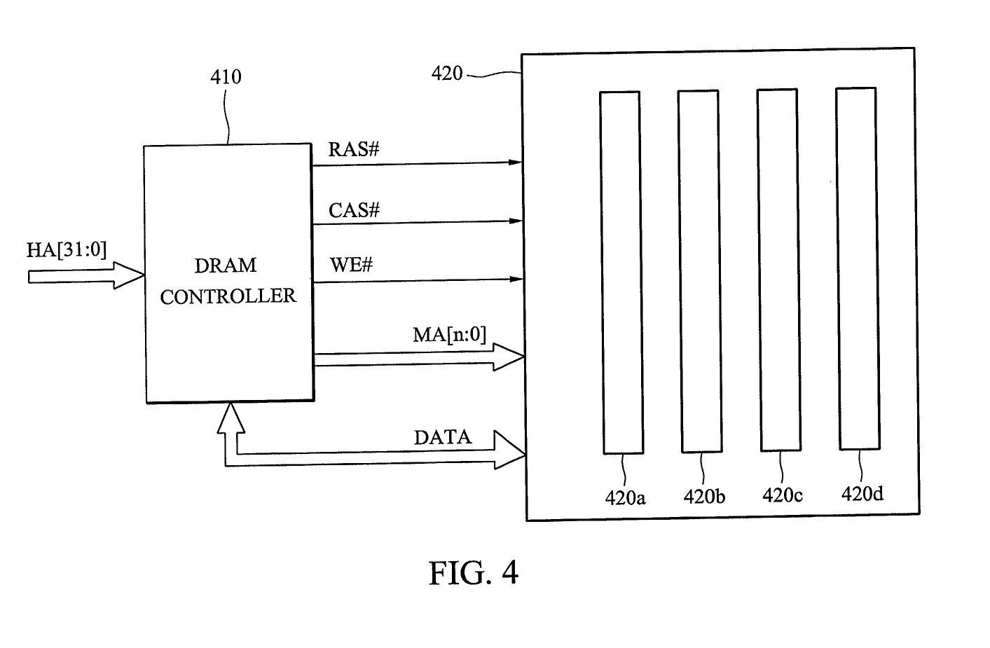

### DETAILED DESCRIPTION OF THE PREFERRED EMBODIMENT

As illustrated in FIG. 3, a memory controller 410 derives a n+1 bits memory address MA[n:0] from a internal address (a.k.a. the physical address) provided from the requester. In a preferred embodiment, the internal address is a 32-bit address HA[31:0]. The memory controller 410 multiplexes row and column addresses on MA[n:0] to a system memory 420. A row address is provided on MA[n:0] followed by a column address or series of column addresses. A suitable system memory 420 comprises memory devices that may be organized in multiple modules, modules 420a˜d for example. However, no particular limitation is placed on the module configuration. Various memory devices may be employed such as dynamic random access memory (DRAM), extended data out (EDO) DRAM, or synchronous DRAM (SDRAM) among others. In some embodiments, each memory device may be further divided into multiple banks.

The memory controller 410 asserts a memory row address strobe (RAS#, where # denotes an active low trigger herein) to strobe the row address on MA(n:0] into the appropriate memory module. The memory controller 410 also provides a memory column strobe CAS# to the system memory 420. After a row address has been entered, CAS# is asserted to strobe a column address on MA[n:0] into the active memory module. The memory controller 410 provides a memory write enable WE# to distinguish between read and write operations. Data is transferred between the memory controller 410 and a system memory 420 on memory data bus MD. For read operations, the selected one of memory modules 420a˜d provides data on data bus MD according to the row and column address. For write operations, the memory controller 410 provides data on data bus MD to be written to the active memory module at the addresses specified by the row and column address.

Page accessing or paging refers to leaving a page open within a memory bank by leaving a row address active within the bank. Subsequent access to the same row (page) may be satisfied by providing only the column address, avoiding the time associated with providing a row address. Therefore, as long as accesses are “page hits”, the accesses may be completed more rapidly. While a “page miss” occurs, the opened page is closed by deasserting RAS# or by a bank deactivate (precharge) command. A new page is then opened by asserting RAS# to strobe in a new row address or by a bank activate (active) command.

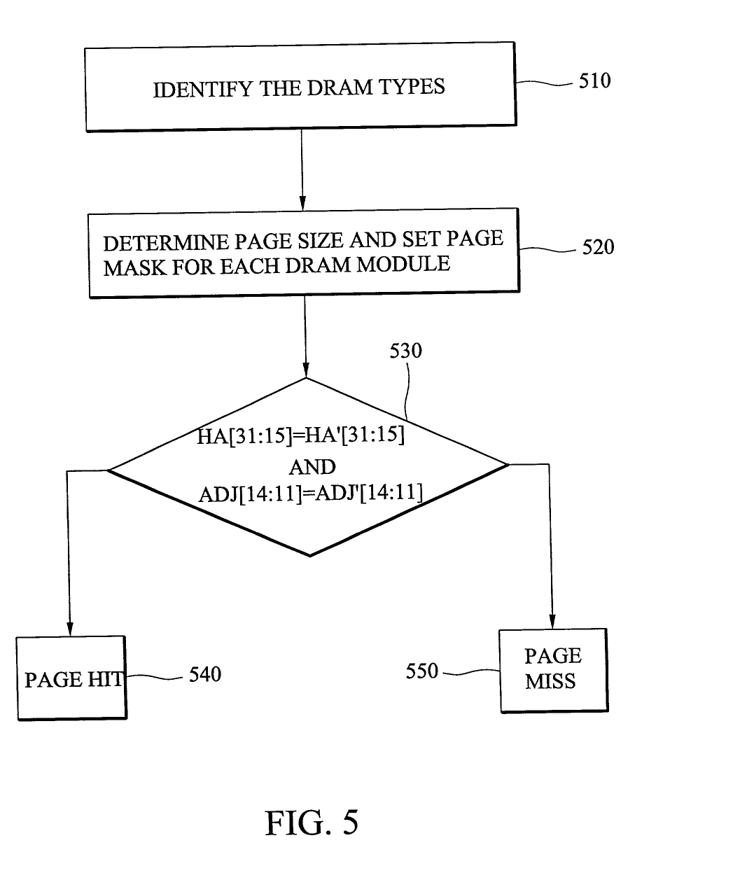

The features of the present invention will be more clearly understood from an example taken in conjunction with the accompanying flowchart. For example, two DRAM modules with type of “2×12×8” are installed in modules 420a and 420b, and two DRAM modules with type of “2×12×10” are installed in modules 420c and 420d, simultaneously. With reference to FIG. 5, the DRAM types of the installed DRAM modules are identified during the computer power-up initialization (step 510). According to the respective DRAM types, the maximum page size of each DRAM module is determined and the page mask for each DRAM module is also set (step 520). The relationships between the DRAM type and the maximum page size and the page mask MK[14:11] are listed in Table 1. Therefore, the maximum page sizes of the modules 420a and 420b are equal to 2 KB both, and the page masks for the module 420a and 420a are [1 1 1 1] both. Similarly, the maximum page sizes of the modules 420c and 420d are equal to 8 KB both, and the page masks for the module 420c and 420d are [1 1 0 0] both.

TABLE 1

| DRAM Type | Maximum Page | Page Mask |
|---|---|---|
| (BA × RA × CA) | Size | MK [4:11] |
| 1 × 11 × 8 | 2 KB | [1 1 1 1] |
| 1 × 13 × 8 | | |
| 2 × 11 × 8 | | |
| 2 × 12 × 8 | | |
| 2 × 13 × 8 | | |
| 1 × 11 × 9 | 4 KB | [1 1 1 0] |
| 1 × 13 × 9 | | |
| 2 × 12 × 9 | | |
| 2 × 13 × 9 | | |
| 1 × 11 × 10 | 8 KB | [1 1 0 0] |
| 1 × 13 × 10 | | |
| 2 × 12 × 10 | | |
| 2 × 13 × 10 | | |
| 2 × 12 × 11 | 16 KB | [1 0 0 0] |
| 2 × 13 × 11 | | |
| 2 × 13 × 22 | 32 KB | [0 0 0 0] |

After completion of the power-up initialization, the DRAM controller 410 responds to the DRAM accesses and performs the read/write transactions. Meanwhile, the DRAM controller 410 stores an internal address for a prior DRAM access. According to the invention, a 32-bit internal address, e.g., physical address, HA[31:0] can be divided into three portions: a first portion HA[31:15], a second portion HA[10:0] and a third portion HA[14:11]. The DRAM controller 410 then receives a next DRAM access which follows the prior DRAM access. The DRAM controller 410 selects one of the DRAM modules as a selected module according to the internal address associated with each received DRAM access.

The DRAM controller 410 masks a third portion of the internal address for the prior DRAM access, HA′[14:11], with the page mask corresponding to a prior selected module, MK′[14:11], to produce an adjustable page portion of the internal address for the prior DRAM access, ADJ′[14:11]. Likewise, the DRAM controller 410 masks a third portion of an internal address for the next DRAM access, HA[14:11], with the page mask corresponding to the next selected module, MK[14:11], to produce an adjustable page portion of the internal address for the next DRAM access, ADJ[14:11]. That is,

ADJ[14:11]=HA[14:11] & MK[14:11]

ADJ′[14:11]=HA′[14:11] & MK′[14:11]

where ‘&’ denotes a logical operator which performs a bitwise AND operation.

The next DRAM access is a page hit or page miss access determined by two conditions (step 530). Condition 1 is whether a first portion of the internal address for the prior DRAM access, HA′[31:15], matches a first portion of the internal address for the next DRAM access, HA[31:15]. Condition 2 is whether the adjustable page portion of the internal address for the prior DRAM access, ADJ′[14:11], matches the corresponding adjustable page portion of the internal address for the next DRAM access, ADJ[14:11] In other words, condition 1 is HA′[31:15]=HA[31:15] and condition 2 is ADJ′[14:11]=ADJ[14:11].

If the both conditions are satisfied, the next DRAM access is a page hit access (step 540). When a page hit access occurs, the next DRAM access is to the same page of the prior DRAM access, only the column address need be strobed in to the selected module. Thus, the RAS precharge time is saved for each subsequent access to the open page. If condition 1 and/or condition 2 can not be satisfied, the next DRAM access is a page miss access (step 550). When a page miss occurs, the opened page is closed by deasserting RAS# or by a precharge command, and a new page is then opened by asserting RAS# to strobe in a new row address or by an active command. No matter what the next DRAM access type is determined as, the DRAM controller 410 maps a second portion of the internal address for the next DRAM access, HA[10:0], according to the maximum page size corresponding to the next selected module, into the column address of the DRAM. Specifically, the address bits of the second portion are consecutive. The detailed relationships between the maximum page size and the column address are listed in Table 2. Note that HA3 is mapped to CA0 due to the data bus of the system memory is 64-bit.

TABLE 2

| | Maximum | | | | | | | | | | | | |
|---|---|---|---|---|---|---|---|---|---|---|---|---|---|
| DRAM Type | Page | Column Address CA[11:0] | | | | | | | | | | | |
| (BA × RA × CA) | Size | CA11 | CA10 | CA9 | CA8 | CA7 | CA6 | CA5 | CA4 | CA3 | CA3 | CA1 | CA0 |
| 1 × 11 × 8 | 2 KB | | | | | HA10 | HA9 | HA8 | HA7 | HA6 | HA5 | HA4 | HA3 |
| 1 × 13 × 8 | | | | | | | | | | | | | |
| 2 × 11 × 8 | | | | | | | | | | | | | |
| 2 × 12 × 8 | | | | | | | | | | | | | |
| 2 × 13 × 8 | | | | | | | | | | | | | |
| 1 × 11 × 9 | 4 KB | | | | HA11 | HA10 | HA9 | HA8 | HA7 | HA6 | HA5 | HA4 | HA3 |
| 1 × 13 × 9 | | | | | | | | | | | | | |
| 2 × 12 × 9 | | | | | | | | | | | | | |
| 2 × 13 × 9 | | | | | | | | | | | | | |
| 1 × 11 × 10 | 8 KB | | | HA12 | HA11 | HA10 | HA9 | HA8 | HA7 | HA6 | HA5 | HA4 | HA3 |
| 1 × 13 × 10 | | | | | | | | | | | | | |
| 2 × 12 × 10 | | | | | | | | | | | | | |
| 2 × 13 × 10 | | | | | | | | | | | | | |
| 2 × 12 × 11 | 16 KB | | HA13 | HA12 | HA11 | HA10 | HA9 | HA8 | HA7 | HA6 | HA5 | HA4 | HA3 |
| 2 × 13 × 11 | | | | | | | | | | | | | |
| 2 × 13 × 12 | 32 KB | HA14 | HA13 | HA12 | HA11 | HA10 | HA9 | HA8 | HA7 | HA6 | HA5 | HA4 | HA3 |

For instance, internal address for a prior DRAM access HA′[31:0] is 800007FFh and internal address for a next DRAM access HA[31:0] is 80000800h. The prior DRAM access opens the page 0 of the module 420c. According to the address 80000800h, the DRAM controller 410 knows that the next DRAM access is to the same module 420c having an 8 KB page size. The page mask for the module 420c is [1 1 0 0] as mentioned above. The DRAM controller 410 compares HA′[31:15] with HA[31:15] and compares ADJ′[14:11] with ADJ[14:11], to determine whether the next DRAM access is a page hit or miss. Since

HA[31:15 ]=1000h

HA′[31:15]=1000h

condition 1, HA[31:15]=HA′[31:15], is satisfied, and

$$\begin{matrix}ADJ [ 14 : 11 ] = HA [ 14 : 11 ] \& MK [ 14 : 11 ] \\ = [ 0 \; 0 \; 0 \; 1 ] \& [ 1 \; 1 \; 0 \; 0 ] \\ = [ 0 \; 0 \; 0 \; 0 ] \\ {ADJ}^{′} [ 14 : 11 ] = {HA}^{′} [ 14 : 11 ] \& {MK}^{′} [ 14 : 11 ] \\ = [ 0 \; 0 \; 0 \; 0 ] \& [ 1 \; 1 \; 0 \; 0 ] \\ = [ 0 \; 0 \; 0 \; 0 ]\end{matrix}$$

condition 2, ADJ[14:11]=ADJ′[14:11], is also satisfied. For the module 420c with 8 KB page size, HA[31:13] is equal to HA′[31:13]. Therefore, the next DRAM access “hits” within the page 0 of the module 420c. The DRAM controller 410 only needs to strobe-in the column address.

As a further example, internal address for a prior DRAM access HA′[31:0] is 7FFh and internal address for a next DRAM access HA[31:0] is 800h. The prior DRAM access opens the page 0 of the module 420a. According to the address 800h, the DRAM controller 410 knows that the next DRAM access is to the same module 420a having an 2 KB page size. The page mask for the module 420a is [1 1 1 1] as mentioned above. The DRAM controller 410 compares HA′[31:15] with HA[31:15] and compares ADJ′[14:11] with ADJ[14:11], to determine whether the next DRAM access is a page hit or miss. Because

HA[31:15]=0

HA′[31:15]=0

condition 1, HA[31:15]=HA′[31:15], is satisfied, but

$$\begin{matrix}ADJ [ 14 : 11 ] = HA [ 14 : 11 ] \& MK [ 14 : 11 ] \\ = [ 0 \; 0 \; 0 \; 1 ] \& [ 1 \; 1 \; 1 \; 1 ] \\ = [ 0 \; 0 \; 0 \; 1 ] \\ {ADJ}^{′} [ 14 : 11 ] = {HA}^{′} [ 14 : 11 ] \& {MK}^{′} [ 14 : 11 ] \\ = [ 0 \; 0 \; 0 \; 0 ] \& [ 1 \; 1 \; 1 \; 1 ] \\ = [ 0 \; 0 \; 0 \; 0 ]\end{matrix}$$

condition 2, ADJ[14:11]=ADJ′[14:11], is not satisfied. Thus, HA[31:11] does not match HA′[31:11] for the module 420a with 2 KB page size, so the next DRAM access “misses” the page 0 of the module 420a. The DRAM controller 410 needs to issue a precharge command to deactivate the open page of the module 420a, and to issue an active command to open a new page within the module 420a.

Accordingly, a method for DRAM control with adjustable page size to raise the page hit rate has been disclosed. The memory control method employs the adjustable page size for various DRAM types and the consecutive address mapping design to achieve a better memory throughput.

While the invention has been described by way of example and in terms of the preferred embodiment, it is to be understood that the invention is not limited to the disclosed embodiment. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for dynamic random access memory (DRAM) control with adjustable page size comprising the steps of:
identifying a DRAM type;
determining a maximum page size of the DRAM and setting a page mask in accordance with the DRAM type;
performing a transaction in response to a prior DRAM access;
receiving a next DRAM access, wherein the next DRAM access follows the prior DRAM access;
respectively determining an adjustable page portion of an internal address for the prior DRAM access and an adjustable page portion of an internal address for the next DRAM access, in accordance with the page mask;
determining if the next DRAM access is a page hit access when a first portion of the internal address for the prior DRAM access matches a first portion of the internal address for the next DRAM access and the adjustable page portion of the internal address for the prior DRAM access matches the corresponding adjustable page portion of the internal address for the next DRAM access; and
mapping a second portion of the internal address for the next DRAM access, in accordance with the maximum page size, into a column address of the DRAM,
wherein address bits of the second portion are consecutive.

2. The method as recited in claim 1 further comprising the steps of:
if the first portion of the internal address for the prior DRAM access does not match the first portion of the internal address for the next DRAM access, performing the steps of:
determining whether the next DRAM access is a page miss access;
issuing a precharge command to the DRAM when the next DRAM access is the page miss access; and
issuing an active command to the DRAM after issuing the precharge command.

3. The method as recited in claim 1 further comprising the steps of:
if the adjustable page portion of the internal address for the prior DRAM access does not match corresponding adjustable page portion of the internal address for the next DRAM access, performing the steps of:
determining whether the next DRAM access is a page miss access;
issuing a precharge command to the DRAM when the next DRAM access is the page miss access; and
issuing an active command to the DRAM after issuing the precharge command.

4. The method as recited in claim 1 wherein the step of determining the adjustable page portion of the internal address for the prior DRAM access and the adjustable page portion of the internal address for the next DRAM access comprises the steps of:
masking a third portion of the internal address for the prior DRAM access with the page mask to produce the adjustable page portion of the internal address for the prior DRAM access; and
masking a third portion of the internal address for the next DRAM access with the page mask to produce the adjustable page portion of the internal address for the next DRAM access.

5. A memory control method for a computer system having a plurality of dynamic random access memory (DRAM) modules installed therein, comprising the steps of:
identifying the DRAM types of the installed DRAM modules;
determining a maximum page size of each DRAM module and setting a page mask for each DRAM module in accordance with the respective DRAM types;
storing an internal address for a prior DRAM access, wherein the internal address includes a first portion, a second portion and a third portion;
receiving a next DRAM access, wherein the next DRAM access follows the prior DRAM access;
selecting one of the DRAM modules as a next selected module, in accordance with an internal address for the next DRAM access;
masking a third portion of the internal address for the prior DRAM access with the page mask corresponding to a prior selected module to produce an adjustable page portion of the internal address for the prior DRAM access;
masking a third portion of an internal address for the next DRAM access with the page mask corresponding to the next selected module to produce an adjustable page portion of the internal address for the next DRAM access;
determining if the next DRAM access is a page hit access when a first portion of the internal address for the prior DRAM access matches a first portion of the internal address for the next DRAM access and the adjustable page portion of the internal address for the prior DRAM access matches the corresponding adjustable page portion of the internal address for the next DRAM access; and
mapping a second portion of the internal address for the next DRAM access, in accordance with the maximum page size corresponding to the next selected module, into a column address of the DRAM,
wherein address bits of the second portion are consecutive.

6. The method as recited in claim 5 further comprising the steps of:
if the first portion of the internal address for the prior DRAM access does not match the first portion of the internal address for the next DRAM access, performing the steps of:
determining whether the next DRAM access is a page miss access;
issuing a precharge command to the DRAM when the next DRAM access is the page miss access; and
issuing an active command to the DRAM after issuing the precharge command.

7. The method as recited in claim 5 further comprising the steps of:
if the adjustable page portion of the internal address for the prior DRAM access does not match corresponding adjustable page portion of the internal address for the next DRAM access, performing the steps of:
determining whether the next DRAM access is a page miss access;
issuing a precharge command to the DRAM when the next DRAM access is the page miss access; and
issuing an active command to the DRAM after issuing the precharge command.
